(19) United States
(12) Patent Application Publication
(10) Pub. No.: US 2011/0259507 A1
(43) Pub. Date: Oct. 27, 2011

(54) Personalizable Calendar Assemblies and Methods

(76) Inventor: Nicholas J. Aynsley, Seattle, WA (US)

(21) Appl. No.: 13/099,289

(22) Filed: May 2, 2011

Related U.S. Application Data
(63) Continuation of application No. 12/341,914, filed on Dec. 22, 2008, now abandoned.
Application No. 12/341,914 is a continuation of application No. 11/708,913, filed on Feb. 20, 2007, now abandoned.

(51) Int. Cl. B32B 38/04

(52) U.S. Cl. 156/92

(57) ABSTRACT

A calendar assembly comprises an intermediate page, a trailing page, and a support structure. The intermediate page comprises an intermediate backing sheet and an intermediate face sheet. The intermediate backing sheet defines an intermediate inner surface and an intermediate exposed surface. The intermediate face sheet is attached to the intermediate backing sheet to define an intermediate material chamber. The trailing page comprises a trailing backing sheet defining an inner surface and an exposed surface. The support structure supports the intermediate page relative to the trailing page such that the intermediate face sheet and the trailing exposed surface of the trailing backing sheet may be configured for viewing adjacent to each other.

### RELATED APPLICATIONS

This application (Attorney's Ref. No. P216704) is a continuation of U.S. patent application Ser. No. 12/341,914 filed Dec. 22, 2008.

U.S. patent application Ser. No. 12/341,914 is a continuation of U.S. patent application Ser. No. 11/708,913 filed Feb. 20, 2007, now abandoned.

All related applications cited in this Related Applications section, including the subject matter thereof, are incorporated herein by reference.

### TECHNICAL FIELD

The present invention relates to calendar assemblies and, more specifically, to calendar assemblies that can easily be personalized with supplemental materials.

### BACKGROUND

Calendars for a primary time period, typically a year, are conventionally sold with one or more calendar images representing a sub time period, typically a month. The images representing the sub time periods may be formed on one or more sheets of paper, but are very often formed with one sub time period formed on a separate sheet of paper. The separate sheets of paper are often bound or otherwise joined using spiral paper connectors.

Calendar publishers have long recognized that calendars comprising a plurality of separate sheets of paper bound by spiral paper connectors present the opportunity for the display of fanciful images in tandem with one or more calendar image. The fanciful images may follow a theme or interest (automobiles), may be associated with a particular month or season (flowers in spring, snow scenes in winter), or in some case may be custom printed for distribution by a particular customer.

Given the costs of printing in small quantities, calendar publishers have difficulty producing calendars customized for individualized users. Computer software may assist in the product of small quantities of calendars for individualize users, but this software may be inconvenient or difficult for some customers to use.

The need thus exists for calendars that allow customers to create customized calendars in small quantities simply and inexpensively.

### SUMMARY

The present invention may be embodied as calendar assembly comprises an intermediate page, a trailing page, and a support structure. The intermediate page comprises an intermediate backing sheet and an intermediate face sheet. The intermediate backing sheet defines an intermediate inner surface and an intermediate exposed surface. The intermediate face sheet is attached to the intermediate backing sheet to define an intermediate material chamber. The trailing page comprises a trailing backing sheet defining an inner surface and an exposed surface. The support structure supports the intermediate page relative to the trailing page such that the intermediate face sheet and the trailing exposed surface of the trailing backing sheet may be configured for viewing adjacent to each other.

The present invention may also be embodied as a method of forming a calendar assembly for displaying a supplemental material comprising the following steps. An intermediate backing sheet and intermediate face sheet are provided. The intermediate backing sheet defines an intermediate inner surface and an intermediate exposed surface. The intermediate face sheet is attached to the intermediate backing sheet to form an intermediate page defining an intermediate material chamber. A trailing page comprising a trailing backing sheet defining an inner surface and an exposed surface is also provided. The intermediate page is supported relative to the trailing page such that the intermediate face sheet and the exposed surface of the trailing backing sheet may be viewed adjacent to each other.

### BRIEF DESCRIPTION OF THE DRAWINGS

FIG. 1 is a front elevation view of an example calendar assembly of the present invention in a closed position;

FIG. 2 is a side elevation view of the example calendar assembly of FIG. 1;

FIG. 3 is a first side elevation view illustrating movement of individual pages of the example calendar assembly of FIG. 1;

FIG. 4 is a second side elevation view illustrating movement of individual pages of the example calendar assembly of FIG. 1;

FIG. 5 is a front elevation view of the example calendar assembly of FIG. 1 in an open configuration;

FIG. 6 is a partial front elevation view of the example calendar assembly of FIG. 1 illustrating insertion of a supplemental material in the form of a photograph into a material chamber;

FIG. 7 is a front elevation view similar to FIG. 6 illustrating an optional process of sealing the supplemental material within the material chamber;

FIG. 8 is a section view taken along lines 8-8 in FIG. 7 illustrating the supplemental material sealed within the material chamber; and

FIGS. 9-11 are section views taken along lines 9-9 in FIG. 7 illustrating the details of one example of the optional process of sealing the supplemental material within the material chamber.

### DETAILED DESCRIPTION

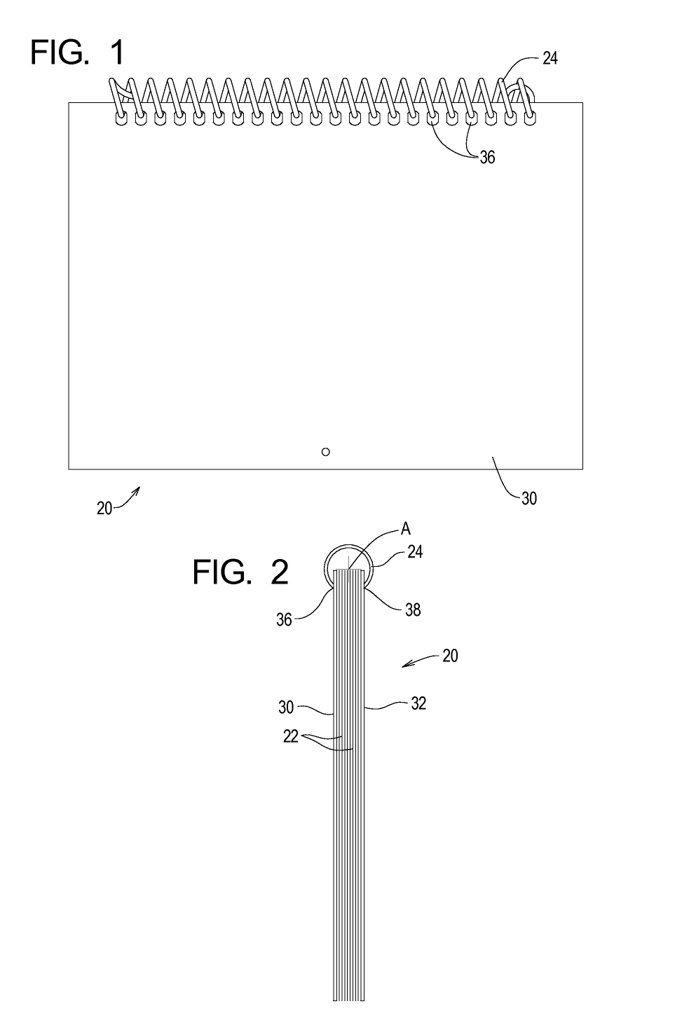

Depicted at FIGS. 1-7 of the drawing is a calendar assembly 20 constructed in accordance with, and embodying, the principles of the present invention. The example calendar assembly 20 comprises a plurality of pages 22 and a binder member 24. The example calendar assembly 20 further comprises optional front and rear cover members 30 and 32. Holes 34, 36, and 38 are formed in the pages 22 and cover members 30 and 32, respectively, and the binder member extends through these holes 34-38 to to join the pages 22 and cover members 30 and 32 together as will be described in further detail below.

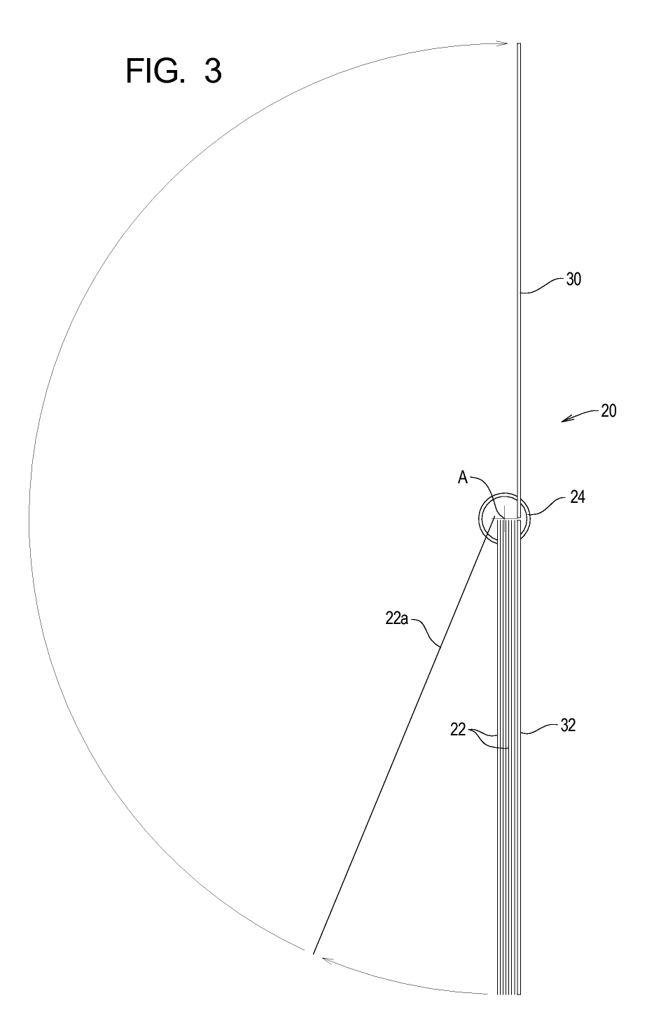

The example calendar assembly 20 may be arranged in a closed configuration as shown in FIGS. 1 and 2 for retail sale and storage or in an open configuration as shown in FIGS. 3-8. The calendar assembly 20 is typically used in the open configuration as will be explained in further detail below.

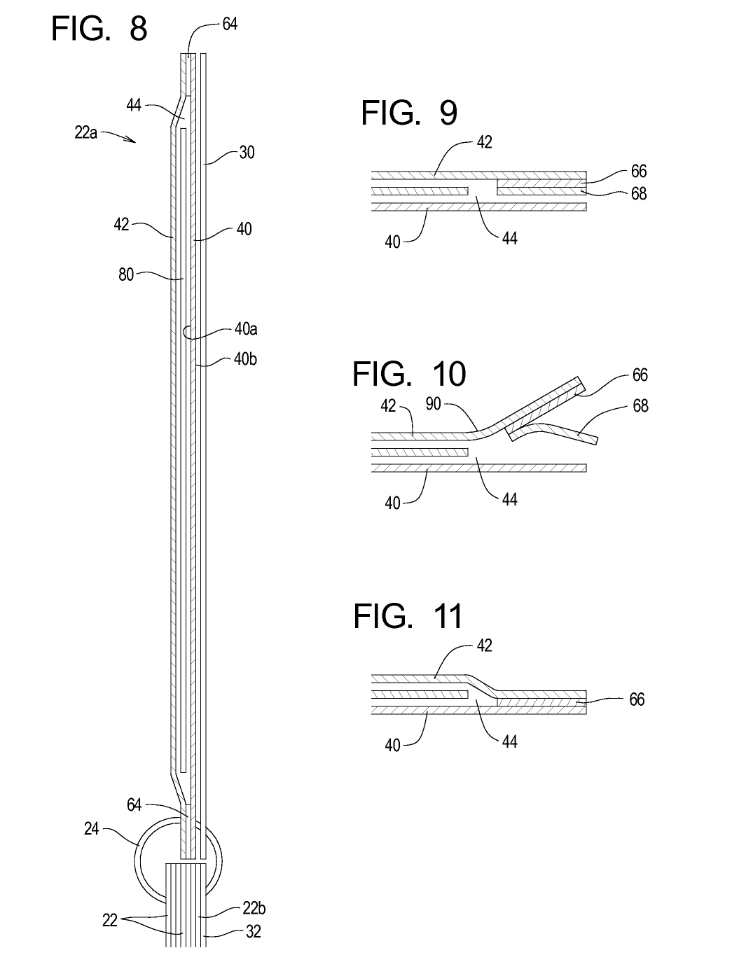

Referring now to FIG. 8, an example of one of the pages 22 is depicted in detail therein. The page 22 depicted in FIG. 8 comprises a backing sheet 40 and a face sheet 42. The face sheet 42 is joined to the backing sheet 40 to define a material chamber 44.

The backing sheet 40 is sufficiently rigid to maintain the entire page 22 in a substantially planar configuration during normal use. The backing sheet 40 defines an inner surface 40a and an exposed surface 40b. When the pages 22 are used in the context of the calendar assembly 20, the exposed surface 40b of at least one of the backing sheets 40 is imprinted with a calendar image 46 represented with a period of time such as a day, week, month, or year.

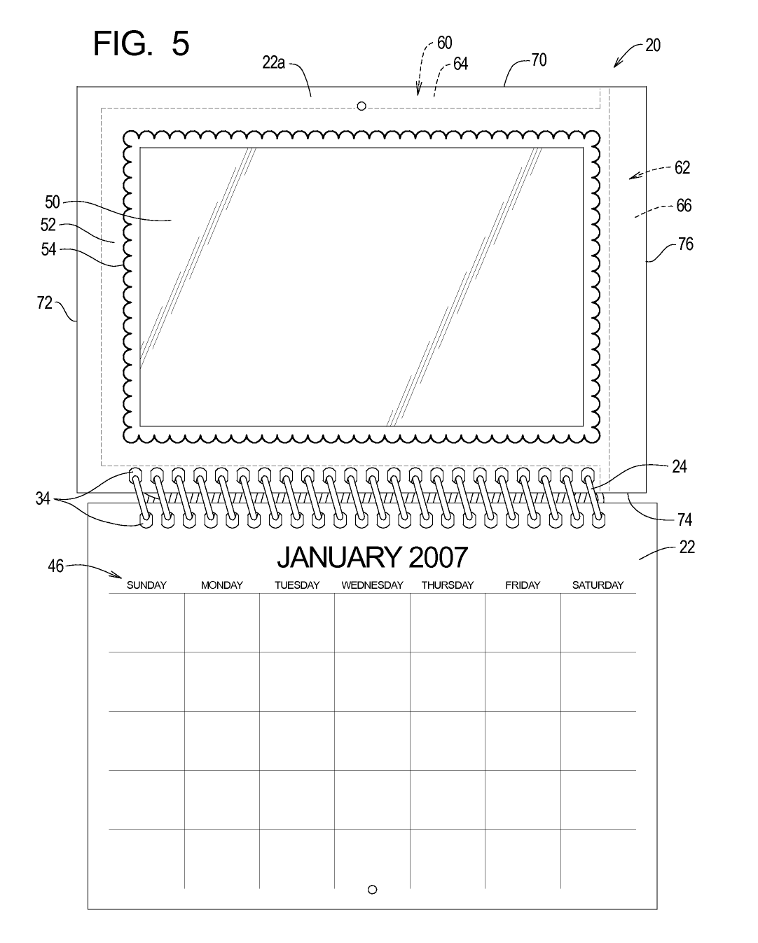

The example calendar assembly 20 depicted in FIGS. 5-7 contains thirteen of the pages 22, and FIGS. 5-7 illustrate the calendar image 46 representing the month of January 2007. The page 22 adjacent to the front cover 30 will be referred to herein as a leading page 22a. A leading page 22a need not have a calendar image formed on the exposed surface 40b of the backing sheet 40 thereof.

The page 22 adjacent to the rear cover 32 will be referred to herein as a trailing page 22b and could be manufactured with only a backing sheet 40 (without a face sheet 42) or with both a backing sheet 40 and a face sheet 42. In the example calendar assembly 20, a calendar image (December 2007) is formed on the exposed surface 40b of the backing sheet 40 of the trailing page 22b.

The middle eleven pages 22 of the example calendar assembly 20 are intermediate pages 22 having both a face sheet 42 and a calendar image 46 formed on the exposed surface 40b of the backing sheet 40.

The example face sheet 42 used by the leading page 22a and the intermediate pages 22 is relatively flexible and is at least partly see-through, as perhaps best shown in FIGS. 5-7. The example face sheet 42 of the leading page 22a or any of the intermediate pages 22 is associated with the calendar image 46 on the exposed surface 40b of the trailing page 22b or one of the intermediate pages 22. In the context of the example calendar assembly 20, each month represented by the calendar image is associated with one of the face sheets 42.

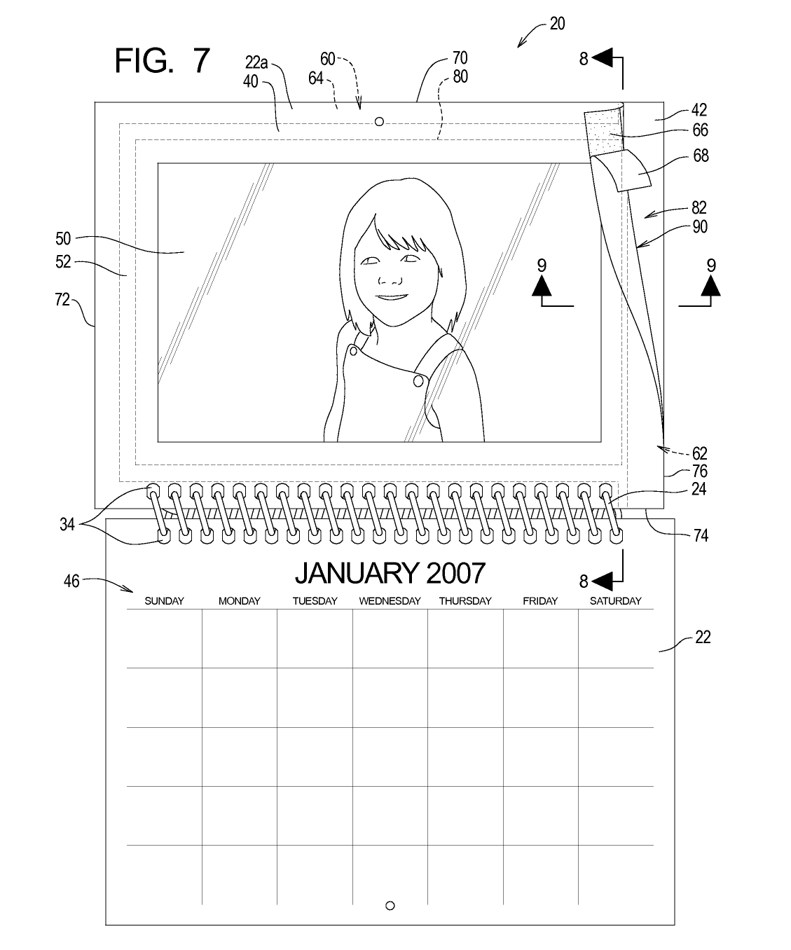

In the context of the example calendar assembly 20, the associated face sheet 42 of one page 22 faces the associated calendar image 46 of the page 22 adjacent thereto when the calendar assembly 20 is in its closed configuration as shown in FIGS. 1 and 2. When the calendar assembly 20 is in its open configuration as shown in FIGS. 3-7, the face sheet 42 and its associated calendar image 46 are substantially coplanar and thus both visible. FIGS. 5 and 7 perhaps best illustrate what the user will see when the calendar assembly 20 is in its open position.

With the foregoing general understanding of the present invention in mind, the details of construction and operation of the example calendar assembly 20 will now be described in further detail.

As perhaps best shown in FIG. 3, the example binder member 24 maintains the pages 22 in a substantially parallel relationship but allows rotation of these pages 22 relative to each other about a binding axis A. The example binder member 24 also maintains the cover members 30 and 32 in a substantially parallel relationship with each other and the pages 22 and allows the cover members 30 and 32 to rotate relative to each other and the pages 22 about the binding axis A. The binder member 24 is conventional in that it is formed by a spiral member that extends through successive holes 34-38.

The example backing sheet 40 of the pages 22 is made of thick paper, card stock, or cardboard. The backing sheet 40 may be made of other materials depending upon factors such as cost, weight, rigidity, environmental conditions, and aesthetics. For example, if the calendar assembly 20 is intended for use in a wet or humid environment, the backing sheet 40 may be made of a sheet of plastic or metal that is less likely to lose rigidity when wet.

The example face sheet 42 is made of solid sheet of plastic. The plastic sheet forming the example page 22 comprises a first portion 50 that is substantially transparent and a second portion 52 that is substantially opaque. The second portion 52 is in the shape of a border that extends around the first portion 50. The example face sheet 42 is rectangular, and the second portion 50 takes the form of a rectangular border that extends around all four sides of the first portion 50. The example first portion 50 is thus also rectangular. The face sheet 42 may be made by, as shown in the example of FIG. 5, printing 54 on a clear sheet of plastic, where the printed area 54 defines the second portion 52 and the unprinted area forms the first portion 50.

Where no overlaid border around the first portion 50 is required or desired, the second portion 52 may be eliminated. In this case, the face sheet 42 may be made of a clear sheet of material without any substantial printed portion. In addition, the second portion 52 may take forms other than a border extending completely around all four edges of the first portion 50. For example, the second portion 52 may extend along fewer than four edges of the first portion 50, may be an irregular shape that defines a non-rectangular first portion 50 (e.g., circular or oval), and/or may take the form of printed words, graphics, or the like 54 that overlays the first portion 50 in some way that is aesthetically desirable.

Alternatively, the face sheet 42 may be made by a solid and/or opaque sheet of material. With the face sheet 42 being made of solid and/or opaque material, the solid and/or opaque material may be attached to the backing sheet 40 such that the backing sheet 40 is not visible through the face sheet 42.

More likely, however, the face sheet 42 made of solid and/or opaque material will be processed such that a portion is removed to define an opening in the face sheet 42. In this case, the opening defines the first portion 50 and the remaining material of the solid and/or opaque sheet defines the second portion 52. A face sheet 42 in which the first portion 50 is defined by an opening may be made of materials, such as paper, cardstock, or the like, that are not inherently transparent. As with a printed second portion 52 as described above, a second portion 52 formed by removing material of a solid and/or opaque sheet may define a first portion 50 in shapes other than rectangular.

Referring now more specifically to FIG. 5 of the drawing, broken lines therein illustrate that the example page 22 comprises a first adhesive region 60 and an optional second adhesive region 62. First and second layers of adhesive material 64 and 66 applied to one or both of the backing sheet 40 and/or face sheet 42 within the example first and second adhesive regions 60 and 62. The example page 22 further comprises an optional release sheet 68 arranged in contact with the second adhesive layer 66 within the second adhesive region 62.

The example page 22 is rectangular and thus defines first, second, third, and fourth edges 70, 72, 74, and 76. The example first adhesive region 60 extends substantially along the first, second, and third edges 70, 72, and 74 of the page 22. In the example page 22, the first adhesive region 60 is formed such that face sheet 42 is adhered, at the time the page 22 is manufactured, to the backing sheet 40 substantially along the first, second, and third edges 70, 72, and 74.

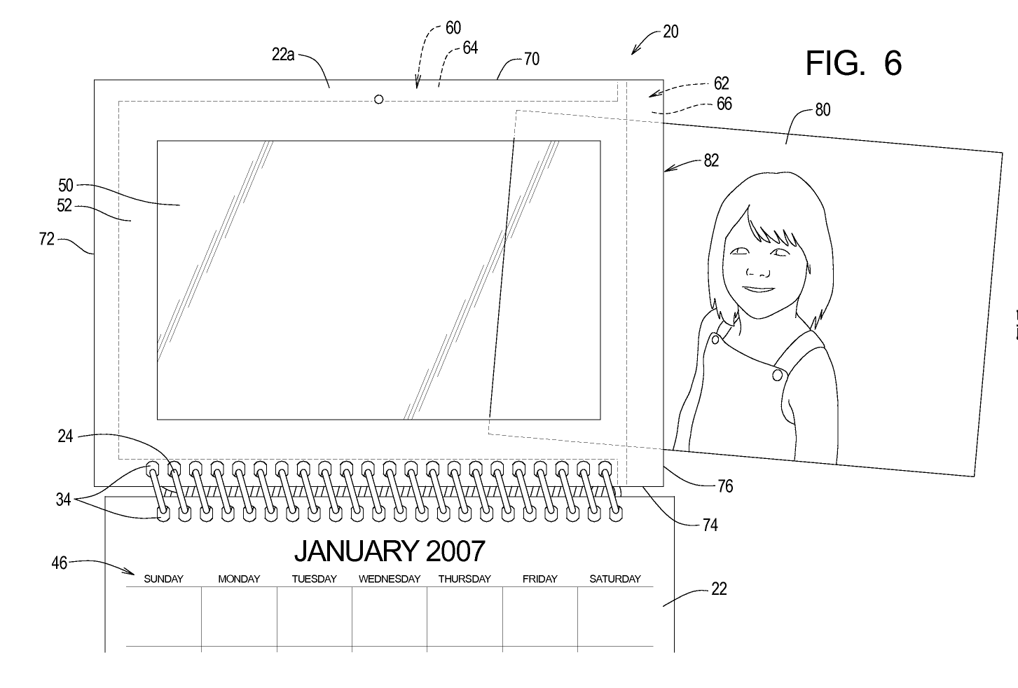

With the face sheet 42 adhered to the backing sheet 40, the page 22 defines a material chamber 44 between the backing sheet 40 and the face sheet 42. A supplemental material 80 may be arranged within the material chamber 44. More specifically, FIG. 6 illustrates the process of inserting a supplemental material 80 taking the form of a photograph into the material chamber 44 through a chamber opening 82 defined between the backing and face sheets 40 and 42 along the fourth edge 76.

The supplemental material 80 may take forms other than a photograph as depicted and described herein. As examples, the supplemental material 80 may take the form of a document commemorating a certain event, a printed page containing an inspirational passage or phrase, a sheet of material on which art or crafts is formed, or generally flat but three-dimensional items such as flowers, leaves, keepsakes, or the like. Another example of a supplemental material 80 that may be inserted into the material chamber 44 would be to include an envelope containing a letter, cash, and/or a check.

In the case of a photograph, at least a portion of the photograph is visible through the substantially transparent first portion 50. In the example page 22 and supplemental material 80 depicted in FIG. 7, the photograph is slightly larger than the first portion 50 of the face sheet 42. The substantially opaque second portion 52 thus forms a border that obscures the edges of the photograph. A substantial portion of the photograph is thus visible through the face sheet 42, but the photograph may be arranged relative to the first portion 50 to frame the photograph in a desirable manner.

The form factor of the supplemental material 80 need not be larger than the area of the first portion 50, however. In this case, the inner surface 40a of the backing sheet 40 will define a background against which the supplemental material 80 is displayed. The colors of the second portion 52 and the inner surface 40a should thus be complementary with each other and with the supplemental material 80. Optionally, a separate background sheet (not shown) may be inserted into the material chamber 44 at least partly behind and/or at least partly in front of the supplemental material 80 to enhance the display of the supplemental material 80.

The example second adhesive region 62 extends substantially along a fourth edge 76 of the page 22. The second adhesive region 62 is not required for any particular implementation of the present invention but is used in situations when it is desirable to at least partly close the chamber opening 82.

If used, the second adhesive region 62 is formed such that the chamber opening 82 may be closed after the supplemental material 80 is inserted into the chamber 44 through the chamber opening 82. In the example page 22, the second layer 66 of adhesive material is applied to one or the other of the backing sheet 40 and face sheet 42 within the second adhesive region 62. The release sheet 68 has a surface area at least as large as the second adhesive region 62 and is applied over the second layer 66 of adhesive material. The release sheet 68 prevents the face sheet 42 from bonding to the backing sheet 40 along the fourth sheet edge 76 at the time of manufacture of the page 22.

The chamber opening 82 thus remains open until the calendar assembly 20 is to be used by the user. At that point, the user may insert any desired supplemental material 80 into the material chamber 44 through the chamber opening 82 as shown in FIG. 6.

In the example page 22, the second layer of adhesive material 66 is formed on the face sheet 42. If the user wishes to close the material chamber 44, a fold 90 is formed in the face sheet 42 to expose the release sheet 68. As is conventional, the release sheet 68 is formed of a material that does not bond well with the adhesive material 66. The exposed release sheet 68 may thus be peeled away from the adhesive material 66 as shown in FIGS. 7 and 10.

Once the release sheet 68 is removed, the face sheet 42 is folded back so that the adhesive material 66 comes into contact with the backing sheet 40. The adhesive material 66 is a pressure sensitive adhesive formulated to bond well with the backing sheet 40, so the adhesive material 66 adheres the face sheet 42 to the backing sheet 40 along the fourth edge 76, thereby effectively closing the chamber opening 82.

Systems and methods of closing the chamber opening 82 other than a pressure sensitive adhesive and release sheet may be used by a page assembly of the present invention. In particular, the face sheet 42 may be joined to the backing sheet 40 using external integrally formed clips, external or integrally formed rivets, integrally formed folds or cuts in one or both of the sheets 40 and 42, and/or liquid adhesive applied to one or both of the sheets 40 and 42.

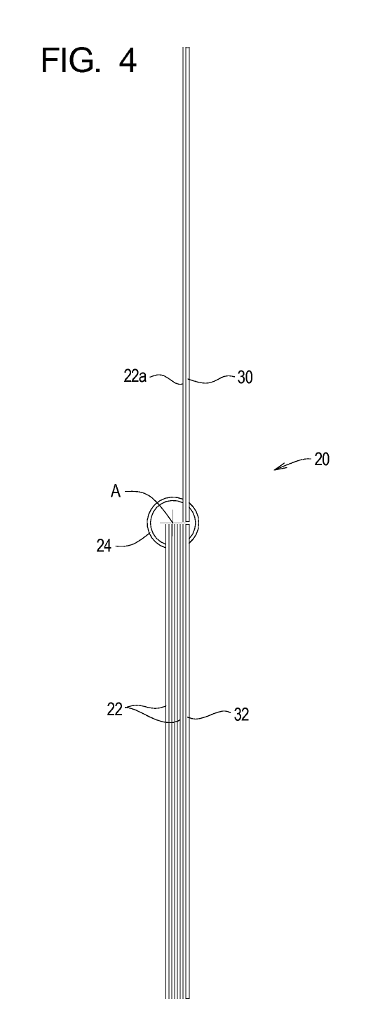

While the pages 22 have significant utility on their own, they are of primary significance in the context of the calendar assembly 20 as described above. However, pages 22 may be joined or associated with each other using means other than the binder member 24 described above. For example, a frame may be provided, and two or more pages 22 may be supported by the frame in a planar relationship similar to that depicted in FIGS. 4, 5, and 7. In addition, instead of having one page for each month, a calendar assembly of the present invention might be implemented with only one of the pages 22 and twelve tear-away sheets, one for each month. The pages 22 may be used for purposes other than forming a calendar assembly.

The present invention may thus be embodied in forms other than described above, and the scope of the present invention should be determined by the claims appended hereto and not the foregoing detailed description of the invention.

What is claimed is:

1. A method of forming a customizable calendar assembly adapted to hold supplemental material, the method comprising the steps of:
s providing a plurality of backing sheets each defining a backing sheet inner surface and a backing sheet exposed surface;
printing calendar graphics on the backing sheet exposed surfaces;
providing a plurality of face sheets, where the face sheets are clear;
printing face sheet graphics on at least a portion of each of the face sheets;
applying first adhesive on the backing sheets within a first adhesive region;
applying second adhesive to the face sheets within a second adhesive region;
bringing a release sheet into contact with the second adhesive on the face sheet to detachably attach the release sheet to the face sheet;
forming a plurality of calendar pages, each defining a material chamber by bringing each of the face sheets into contact with the first adhesive on the backing sheet of one of the backing sheets, wherein
the first adhesive region extends along first, second, and third edge of each of the calendar pages and the second adhesive region extends along a fourth edge of each of the calendar pages,
the release sheet is configured
to prevent the second adhesive from bonding with the backing sheet when the calendar pages are in an open configuration in which access to the material chamber is allowed, and
to be removed to allow the second adhesive to bond with the backing sheets in the second adhesive region when the calendar pages are in a closed configuration in which access to the material chamber is substantially prevented,
a first portion of the inner surface of the backing sheet is visible through face sheet,
a second portion of the inner surface of the backing sheet is obscured by the face sheet graphics,
the material chamber is sized and dimensioned to receive the supplemental material such that at least a portion of the supplemental material is visible through the face sheet;
forming a plurality of binder holes along the third edges of each of the calendar pages substantially within the first adhesive region;
arranging a binder member within at least some of the plurality of binder holes to form a calendar assembly in which the calendar graphics on one of the calendar pages and supplemental material within material chamber of another of the calendar pages are simultaneously visible;
placing supplemental material within the material chambers with the calendar pages in the open configuration; and
removing the release sheets; and
bringing the face sheets into contact with the second adhesive to place the calendar pages in the closed configuration.
